(19) United States
(12) Patent Application Publication
(10) Pub. No.: US 2021/0007833 A1
(43) Pub. Date: Jan. 14, 2021

(54) SUPPORT SYSTEM FOR THE MANUFACTURE OF DENTAL RESTORATIONS, AS WELL AS DENTAL RESTORATION SYSTEM

(71) Applicant: VITA ZAHNFABRIK H. RAUTER GMBH & CO., KB, Bad Saeckingen (DE)

(72) Inventor: Wolfgang Rauh, Bad Saeckingen (DE)

(73) Assignee: VITA ZAHNFABRIK H. RAUTER GMBH & CO., KB, Fairhaven, MA (US)

(21) Appl. No.: 16/910,617

(22) Filed: Jun. 24, 2020

(30) Foreign Application Priority Data
Jul. 9, 2019 (EP) 19185116.1

(51) Int. Cl. A61C 13/00; A61C 13/083

(52) U.S. Cl. CPC A61C 13/0004; A61C 13/083; A61C 13/0019

(57) ABSTRACT

A support system for the manufacture of dental restorations comprises a measuring device which acquires the restoration tooth data of a dental restoration. The restoration tooth data acquired are transmitted to a data processing device connected with a measuring device. The data processing device comprises an analysis module that compares the restoration tooth data with previously determined target tooth data, i.e. patient tooth data. A display device that displays the comparison result is integrated in the data processing device.

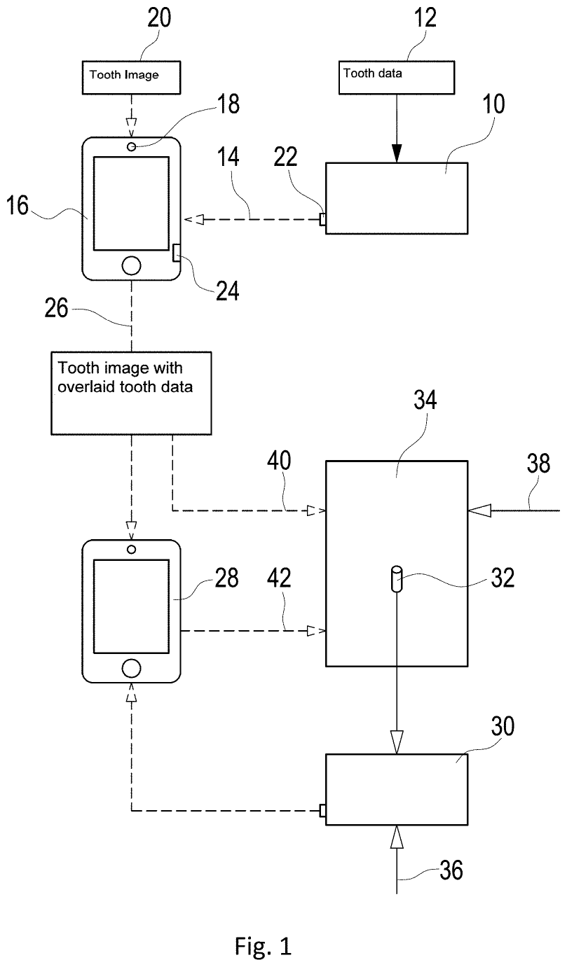

### BACKGROUND

### 1. Field of the Disclosure

The disclosure relates a support system for the manufacture of dental restorations, as well as to a dental restoration system.

### 2. Discussion of the Background Art

For the manufacture of dental restorations, it is required that the treating person, usually a dentist, determines tooth data of the tooth to be restored which data also include the tooth color. Typically, the tooth color is typically communicated by indication of a color sample from a dental color system (e.g. VITA classical A1-D4® or VITA System 3D-MASTER®), while the color coordinates brightness, chroma and shade are transmitted in addition thereto, thus allowing a more exact description of the tooth color. The tooth color and the color coordinates may be determined using suitable measuring devices. A device suited for this purpose is the measuring device VITA Easyshade® of VITA Zahnfabrik. In the next step it is required to take a photograph of the respective tooth of the patient. Nowadays, capturing such a tooth image is done using a digital camera.

Further, the geometrical data are acquired in the patient's mouth so as to determine the required spatial data e.g. for the manufacture of an inlay, a crown or a prosthesis. This may be done in a conventional manner by means of a dental impression, while it is also possible to perform a digital acquisition of the geometric data using an intraoral scanner.

The geometric data, as well as the tooth data are then transmitted to a dental laboratory in which the dental restoration such as an inlay, a bridge or a dental prosthesis or the like is manufactured. In the case of a ceramic dental restoration, the dental restoration is manufactured such that the dental restoration is first modeled on the basis of the geometric data either virtually on a CAD system and is subsequently manufactured physically using a processing machine or a 3D printer or manually using the impression, typically by manually applying a plurality of material layers. The manufactured restoration is then fired in a sintering furnace if the material used requires so. A fact particularly noteworthy in this context is that in the manual manufacture of restorations from ceramic materials, often a plurality of firing processes in a dental furnace is performed, for example one firing process after each application of a material layer. Here, the tooth data are used in particular to define the corresponding material selection, material thickness etc.

A dental technician compares the manufactured dental restoration with the previously acquired tooth data, i.e. the target tooth data. In the case of manual manufacture this is usually done after each firing. For this purpose, the dental technician uses color samples from a dental color system and compares e.g. the tooth color of the dental restoration with the desired color present in the color system. Since the manufacturing process of a dental restoration will not yield the exact desired result already in the case of even slight deviations e.g. in the material selection, the layer thickness of the material applied, the temperature and also the temperature profile of the sintering furnace, it is common to take correction measures. This may e.g. be a post-firing of the dental restoration, the application of a paint on the surface of the finished dental restoration and the like. Primarily in the case of manual manufacture, a possibility for correction is to select the color of the material for the next material layer to be applied based on the color values or the color deviation between the target color of the restoration and the current color of the present work-piece and to thereby minimize the color deviation of the finished restoration. Thus, the dental technician faces the problem to select suitable additional treatment measures for the dental restoration if the dental restoration does not show the required tooth data, i.e. the target tooth data.

It is an object of the disclosure to provide a support system for the manufacture of dental restorations, which supports the dental technician in the manufacture of dental restorations.

### SUMMARY

The support system of the present disclosure comprises a measuring device which in particular is the measuring device VITA Easyshade® or which is integrated in the measuring device VITA Easyshade® or a corresponding device. Using the measuring device, the restoration tooth data, in particular the tooth color, as well as the tooth coordinates, i.e. in particular the brightness, the chroma and the shade of a dental restoration, are measured. Thus, the measuring device is used to acquire the restoration tooth data of a dental restoration. For example, after the firing of a dental restoration in a sintering furnace, the restoration tooth data are thus determined using the measuring device.

Further, according to the disclosure, the measuring device is connected or can be connected with a data processing device. Likewise, a direct connection may be made such that the data processing device is integrated in the measuring device. The data processing device transmits the measured restoration tooth data. According to the disclosure, an analysis module is provided in the data processing device. A comparison between the measured restoration tooth data and previously defined or fixed target tooth data is performed by means of the analysis module. The target tooth data are tooth data which are defined in particular by a dentist.

Furthermore, a display device is integrated in or connected with the data processing device. It is particularly preferred that the data processing device and also the display device are integrated in the measuring device so that the dental technician has to operate only a single device. The display device serves to display an analysis result. The analysis result is in particular the deviation between the restoration tooth data and the target tooth data. If so desired, the display device may in addition display the target tooth data and/or the restoration tooth data. Thus, an exact determination and an exact comparison between the restoration tooth data and the target tooth data is thus effected for the dental technician. In this manner a very precise determination of the deviations may be made.

The dental technician may then take suitable measures on the basis of the deviations determined, so as to further process the dental restoration in such a manner that the same ideally shows the target tooth data. Suitable measures for this are e.g. firing the dental restoration again with a suitable firing characteristic, applying paint on the surface of the dental restoration, using materials whose color doses not correspond to the desired tooth color of the restoration so as to compensate for the detected color deviations.

In a particularly preferred development of the support system according to the disclosure a catalogue of measures is stored in the data processing device. Thus, it is possible for the data processing device to define a treatment measure for improving the data restoration or for improving the restoration tooth data or to recommend such measures to the dental technician, based on the result of the comparison between the restoration tooth data and the target tooth data. In a preferred embodiment, this treatment measure automatically determined by the data processing device is outputted on the display device.

A check of the dental restoration may of course be again made after a treatment measure has been performed, so as to perform another treatment measure, if necessary, if the newly measured restoration tooth data still deviate from the target tooth data.

In a further preferred embodiment, the data processing device which in particular is integrated in the measuring device, comprises an input module. Additional restoration tooth data can be inputted using the input module. These additional restoration tooth data may e.g. be data acquired by the dental technician which were determined e.g. with the aid of color samples and serve to complement the automatically acquired tooth data. Moreover, the dental technician could perform further measurements such as the hardness of the surface of the dental restoration or the like, and the corresponding data may be inputted. Here, as an input module, a keyboard may be provided immediately at the data processing device, in particular at the measuring device, or may be adapted for connection therewith. Further, data input may be made via data transmission so that the measuring device or the data processing device comprises a transmission and/or receiving module, such that corresponding data may be transmitted electronically e.g. via Bluetooth or in another manner of data transmission. Further, corresponding data transmission may be made via a USB interface or the like.

Preferably, these additional restoration tooth data are considered by the analysis module in the comparison with the target tooth data and preferably also in defining a treatment measure.

The disclosure further refers to a dental restoration system. The dental restoration system comprises a restoration device, e.g. a sintering furnace, for the sintering of ceramic teeth. The restoration device may also be a 3D printer. Further, the dental restoration system of the present disclosure comprises a support system described above.

It is particularly preferred that the dental restoration system of the disclosure further comprises a data acquisition system for acquiring tooth data of the patient. Such a data acquisition system, which may e.g. the measuring device VITA Easyshade® for an automatic acquisition of tooth data, can be connected either directly or indirectly with the restoration device for the transmission of the determined target tooth data, i.e. the tooth data of the patient. In the case of a direct connection, e.g. the restoration device, such as the sintering furnace, may select a corresponding firing program on the basis of the target tooth data. If so desired, the dental technician enters or transmits additional data to the restoration device. For example, in the case of a ceramic dental restoration, these are in particular the materials used. If the restoration device is a 3D printer, it would be possible that the data acquisition system also acquires the geometrical data, while it is understood that this may be effected by means of an additional device, so that, in addition to a measuring device for the acquisition of the tooth data, the data acquisition system comprises a device for the acquisition of geometrical data, such as a 3D scanner.

The data acquisition system is advantageously developed as described below.

The data acquisition system comprises a measuring device for the in particular automatic measuring of target tooth data. The target tooth data are in particular the tooth color as well as the color coordinates brightness, chroma and shade. Further, the data acquisition system further comprises a data processing device with a camera for capturing a tooth image. In a particularly preferred embodiment, the data processing device is a mobile data processing device such as a mobile phone, in particular a smartphone or a tablet computer. With such a data processing device it is possible on the one hand to capture a tooth image of the teeth to be restored, using the camera, and to also process data on the other hand. For this purpose, the data processing device comprises a receiving module and the measuring device comprises a transmission module for the direct transmission of measured tooth data from the measuring device to the data processing device.

Preferably, the data processing device comprises an integrated allocation module. This is in particular a corresponding software which may e.g. be configures as an app. The allocation module serves to allocate the received tooth data to the tooth image captured by the data processing device itself. Thus, an extremely simple and reliable allocation is possible for the person operating the data acquisition system, in particular the dentist. The dentist may e.g. first acquire the tooth data, transfer the same directly to the mobile phone or the like and may in particular take a tooth image thereafter, so that a direct allocation of the tooth data to the tooth image is performed. Allocation errors are thereby excluded. Likewise, it is of course also possible to first take the tooth image and to then transfer the tooth data to the mobile phone or the like, so that, again, a clear allocation is performed. Thus, the handling is clearly much simpler for the operator, in particular the dentist. The step of transferring the tooth image to a computer is omitted. The allocation of the transmitted tooth image to the tooth data also transmitted to the computer can also be omitted. Specifically, a computer with a corresponding software for the allocation of the data is no longer required.

The tooth data and data of the tooth image stored on the data processing device, such as a mobile phone, and allocated to each other can be transferred in a simple manner e.g. from the mobile phone to a data processing device of a dental laboratory and/or directly to the restoration device via a transmission module which is provided in the data processing device anyway. It is particularly advantageous that this can be done by the dentist immediately after the allocation of the data sets e.g. on the mobile phone.

It is particularly preferred that the data processing device of a dental laboratory also is a mobile phone, a tablet computer or the like. The handling is clearly simplified also on the receiving side, i.e. at the technician in the dental laboratory. The dental technician receives the corresponding data immediately on his cell phone, his tablet or the like. Such a receiving device simplifies the handling. As such, these devices meet with much higher acceptance.

In order to realize a communication between the devices that is as simple as possible, it is particularly preferred that the data transmission between the measuring device and the data processing device, such as the mobile phone or the like is wireless. Specifically, this may be effected via a NFC interface, Bluetooth or WLAN.

Specifically, for a bilateral data transfer and/or for data synchronization it is further preferred that both the measuring device and the data processing means, such as the mobile phone, comprise a transmission and receiving module to allow for wireless communication between the two devices.

Data transmission to the data processing device of a dental laboratory and/or to the restoration device is preferably effected via remote data transmission, in particular via the mobile network.

The data acquisition device may also be configured such that the measuring device and the data processing device are combined into one device. As such, the dentist has to handle only a single device with which the acquisition of the patient tooth data, the capturing of a tooth image, as well as the allocation and transmission of the data can be performed.

In a further, independent disclosure, a dental restoration system comprises a data acquisition system as described above, but not the above-described support system. Thus, such a dental restoration system exclusively acquires data on the patient side and transmits the corresponding data to the dental laboratory onto a corresponding device of the dental technician. This has the advantage that the all data are immediately available to the dental technician on his mobile device. The dental technician can then compare the transmitted image with the actual dental situation in a simple manner and can thus perform known treatment measures should the dental restoration not match the image and the transmitted data.

The disclosure will be described below in more detail with respect to a preferred embodiment and to the accompanying drawing.

### BRIEF DESCRIPTION OF THE DRAWINGS

The FIGURE is a schematic illustration of a preferred embodiment of the dental restoration system with the data acquisition device and the support system for the manufacture of dental restorations.

### DETAILED DESCRIPTION OF THE PREFERRED EMBODIMENT

The data acquisition system for the manufacture of dental restorations of the present disclosure comprises a measuring device 10. The measuring device 10 is in particular the measuring device VITA Easyshade®. Using the measuring device, patient tooth data 12 are obtained in particular by the dentist. The patient tooth data, possibly treated or processed in the measuring device 10, are transmitted to a data processing device, such as a mobile phone 18, in particular via a Bluetooth link 14. The transmission may also be performed in another manner onto other data transmission systems or in a wired manner. Using the mobile phone, a tooth image 20 is generated by means of the camera 18 integrated in the mobile phone, either before or after the transmission of the tooth data. Instead of using a mobile phone 16, it is of course possible to provide a data processing device in the form of a computer or the like and to transmit the tooth image by means of a separate camera and to the data processing device either in a wired manner or by remote data transmission.

By means of a software or app existing on the mobile phone 16, an allocation of the transmitted tooth data 12 to the captured tooth image 20 is performed.

For data transmission between the mobile phone 16 and the measuring device 10, the measuring device 10 preferably comprises a transceiver device 22 and the mobile phone 16 likewise comprises an integrated transceiver device 24. This allows for data exchange in both directions or for data synchronization.

Then the tooth image, together with the allocated tooth data, is transferred via the conventional transmission module integrated in the mobile phone 16, e.g. via a mobile network 26, to a data processing device of a dental laboratory which in particular is a mobile phone 28 itself.

Besides the above-described data acquisition system, the preferred embodiment of the dental restoration system illustrated in the FIGURE comprises a support system. The support system comprises a measuring device 30 which preferably corresponds to the measuring device 10. Using the measuring device 30, which thus again preferably is the measuring device VITA Easyshade®, restoration tooth data of a dental restoration 32 are acquired. The dental restoration 32 was sintered e.g. in a sintering furnace 34. The dental restoration data measured by the measuring device 30 are transmitted to a data processing device which in the embodiment illustrated again is the mobile phone 28. Of course, it may also be another data processing device. Data transmission is again effected in a wired manner, via Bluetooth or another remote data transmission. Using the analysis module which may be provided as an app on the mobile phone 28, a comparison of the patient tooth data determined by the measuring device 10 is performed. The comparison result can be displayed on the display of the mobile phone 28, possible together with the restoration tooth data and/or the patient tooth data. Preferably. The data processing device 28 further includes a catalogue of measures. Thereby, it is possible for the analysis module to suggest, in dependence on the comparison result, measures from the catalogue of measures for the further treatment of the dental restoration 32 and to display these on the display of the mobile phone 28 as well.

In addition to the restauration data measured by means of the measuring device 30, a dental technician can also acquire tooth data, e.g. by means of a dental color system, and input the same for correction purposes. The data input may be made either at the measuring device 30, as illustrated by the arrow 36, or may also be made directly at the data processing device 28.

For the manufacture of the dental restoration 32, data are transmitted e.g. in the sintering furnace 34, as illustrated by the arrow 38, which define a firing program or by which the sintering furnace 34 selects a firing program. Possibly, these may also or in addition be tooth data 12 which are transmitted to the restoration device 34 as indicated by the arrow 40. The data for an additional treatment measure, which are defined be the data processing device 28, can also be transmitted directly to the restoration device 34 as indicated by the arrow 42.

What is claimed is:

1. Support system for the manufacture of dental restorations, comprising
a measuring device determining restoration tooth data, in particular the tooth color as well as color coordinates of a tooth restoration,
a data processing device connected or connectable with the measuring device for transmitting the measured restoration tooth data,
an analysis module for comparing the measured restoration tooth data with determined target tooth data, said module being provided in the data processing device, and
a display device for displaying an analysis result, said device being connected with the data processing device.

2. Support system of claim 1, wherein the data processing device includes a catalogue of measures stored therein so that the data processing device defines a treatment measure for improving the dental restoration in dependence on the comparison result.

3. Support system of claim 2, wherein the defined treatment measure is outputted on the display device.

4. Support system of claim 1, wherein the data processing device comprises an input module for inputting additional restoration tooth data.

5. Support system of claim 4, wherein the analysis module takes the inputted additional restoration tooth data into account in the comparison and in particular when defining a treatment measure.

6. Support system of claim 1, wherein the data processing device and/or the display device are integrated in the measuring device.

7. Dental restoration system for the manufacture of dental restorations, comprising
a restoration device, in particular a sintering furnace for sintering ceramic teeth, and
a support system as defined in claim 1.

8. Dental restoration system of claim 7, further comprising a data acquisition system for acquiring patient tooth data, said system being connectable with the restoration device for the transmission of data.

9. Dental restoration system of claim 8, wherein the data acquisition system comprises:
a measuring device determining patient tooth data, in particular the tooth color as well as color coordinates,
a data processing device with a camera for capturing a tooth image,
wherein the data processing device comprises a receiving module and the measuring device comprises a transmission module for the immediate transmission of measured patient tooth data from the measuring device to the data processing device,
an allocation module for the allocation of the received tooth data to the tooth image, said module being integrated in the data processing device, and
a transmission module for the transmission of the tooth image including the allocated tooth data to the restoration data, said module being integrated in the data processing device.

10. Dental restoration system of claim 9, wherein automatic data acquisition of at least a part of the patient tooth data is performed using the measuring device.

11. Dental restoration system of claim 9, wherein the camera is integrated in the data processing device.

12. Dental restoration system of claim 9, wherein the data processing device is configured as a mobile data processing device.

13. Dental restoration system of claim 9, wherein the data transmission between the measuring device and the data processing device is performed in a wireless manner.

14. Dental restoration system of claim 9, wherein the measuring device and the data processing device comprise a transceiver module for the exchange of data or the synchronization of data with the data processing device to the measuring device.

15. Dental restoration system of claim 9, wherein a transmission module of the data processing device is configured for data transmission to the restoration device, possibly via a data processing device of a dental laboratory, for remote data transmission in particular via mobile networks.

16. Dental restoration of claim 7, wherein a data processing device of a dental laboratory is arranged upstream of the restoration device, said a data processing device preferably comprising a display device.
